(19) United States
(12) Patent Application Publication
(10) Pub. No.: US 2025/0230934 A1
(43) Pub. Date: Jul. 17, 2025

(54) APPLIANCE WITH THERMAL ELEMENT

(71) Applicant: WHIRLPOOL CORPORATION, BENTON HARBOR, MI (US)

(72) Inventors: ANKUR GARG, PUNE (IN); HANKS HU, SHENZHEN (CN); EVAN HUANG, SHENZHEN (CN); RYAN LI, SHENZHEN (CN)

(73) Assignee: WHIRLPOOL CORPORATION, BENTON HARBOR, MI (US)

(21) Appl. No.: 18/700,458

(22) PCT Filed: Oct. 13, 2021
(86) PCT No.: PCT/CN2021/123590

§ 371 Date: Apr. 11, 2024

(51) Int. Cl. F24C 15/32; A47J 37/06; H05B 3/12

(52) U.S. Cl. CPC F24C 15/325; A47J 37/0641; H05B 3/12; H05B 2203/013

(57) ABSTRACT

An appliance (20) includes a housing (24), a plurality of walls (28), a cavity (32), an access aperture (36), a closure panel (40), a forced-air assembly (44), and a thermal element (48). The walls (28) are positioned within the housing (24). The walls (28) include a first side wall (52), a second side wall (56), a top wall (60), a bottom wall (64), and a rear wall (68). At least one of the walls (28) defines a series of apertures (72) therein. The cavity (32) is defined by the walls (28). The access aperture (36) is positioned opposite the rear wall (68). The closure panel (40) is coupled to a front of the housing (76). The closure panel (40) is movable between an open position and a closed position. The closure panel (40) is configured to cover the access aperture (36) when the closure panel (40) is in the closed position. The forced-air assembly (44) is configured to induce airflow within the cavity (32).

### CROSS-REFERENCE TO FOREIGN PRIORITY APPLICATION

The present application claims the benefit under 35 U.S.C. § 119(b), 119(e), 120, 121, 365(c), and/or 386(c) of PCT/CN2021/123590 filed Oct. 13, 2021.

### BACKGROUND OF THE DISCLOSURE

The present disclosure generally relates to an appliance. More specifically, the present disclosure relates to an appliance with a thermal element.

### SUMMARY OF THE DISCLOSURE

According to one aspect of the present disclosure, an appliance includes a housing, a plurality of walls, a cavity, an access aperture, a closure panel, a forced-air assembly, and a thermal element. The plurality of walls are positioned within the housing. The plurality of walls include a first side wall, a second side wall, a top wall, a bottom wall, and a rear wall. At least one of the plurality of walls defines a series of apertures therein. The cavity is defined by the plurality of walls. The access aperture is positioned opposite the rear wall. The closure panel is coupled to a front of the housing. The closure panel is movable between an open position and a closed position. The closure panel is configured to cover the access aperture when the closure panel is in the closed position. The forced-air assembly is configured to induce airflow within the cavity. The thermal element is positioned upon the at least one of the plurality of walls that defines the series of apertures. The thermal element defines a series of holes. The series of holes are configured to align with the series of apertures. Air is heated by the thermal element as the air passes through the series of holes.

According to another aspect of the present disclosure, an appliance includes a housing, a cavity, and access aperture, a plurality of walls, a closure panel, a forced-air assembly, and an interior panel. The cavity is defined by the plurality of walls. The access aperture is positioned opposite the rear wall. The plurality of walls are positioned within the housing. At least one of the plurality of walls defines a series of apertures therein. The closure panel is coupled to a front of the housing. The closure panel is movable between an open position and a closed position. The closure panel is configured to cover the access aperture when the closure panel is in the closed position. The forced-air assembly is configured to induce airflow within the cavity. The forced-air assembly includes a motor, a driveshaft, and an air-moving member. The interior panel is positioned between the housing and at least one of the plurality of walls. The interior panel supports the motor of the forced-air assembly. The driveshaft of the forced-air assembly extends through the interior panel. The interior panel is contoured such that a recessed area is defined by the interior panel. At least a portion of the motor is positioned within the recessed area.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front perspective view of an appliance, illustrating a closure panel in an open position, according to one example;

FIG. 2 is a cross-sectional view of the appliance, taken at line II-II, illustrating an airflow induced within a cavity of the appliance, according to one example;

FIG. 3 is a schematic representation of the appliance, illustrating a forced-air assembly, according to one example;

FIG. 4 is a schematic representation of the appliance, illustrating the forced-air assembly, according to another example;

FIG. 5 is a schematic representation of the appliance, illustrating the forced-air assembly, according to another example;

FIG. 6 is a schematic representation of the appliance, illustrating the forced-air assembly, according to another example; and

FIG. 7 is a schematic representation of the appliance, illustrating the forced-air assembly, according to another example;

The components in the figures are not necessarily to scale, emphasis instead being placed upon illustrating the principles described herein.

### DETAILED DESCRIPTION

The present illustrated embodiments reside primarily in combinations of method steps and apparatus components related to a heating apparatus. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

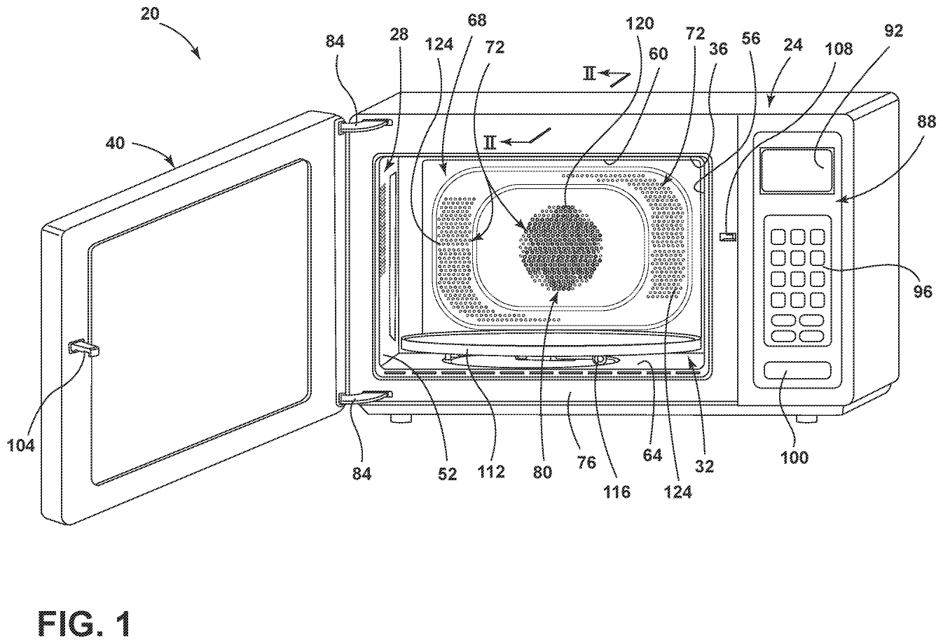

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

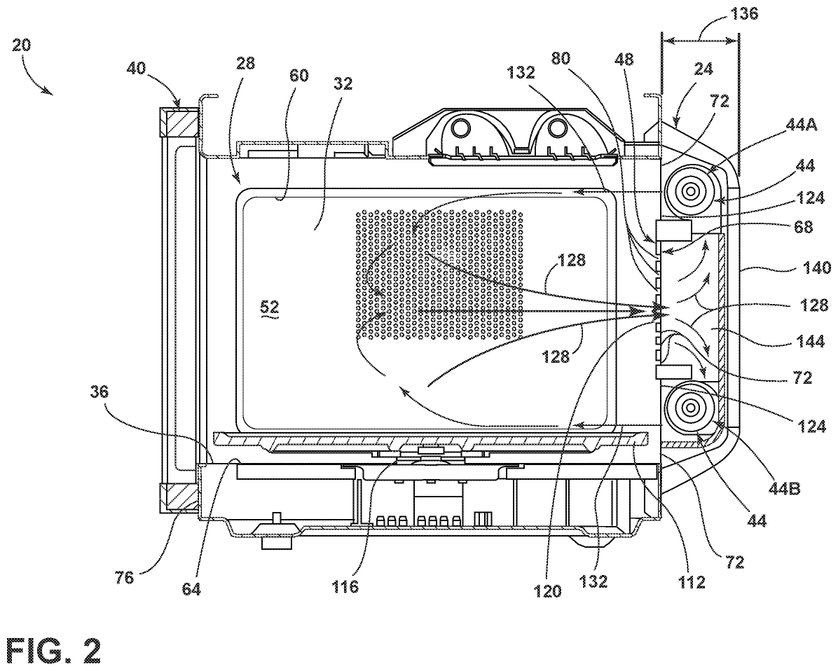

Referring to FIGS. 1-7, reference numeral 20 generally indicates an appliance. The appliance 20 may be any of a number of cooking appliances. For example, the appliance 20 may be an oven, a microwave oven, a toaster oven, and/or an air fryer. The appliance 20 includes a housing 24, a plurality of walls 28, a cavity 32, an access aperture 36, a closure panel 40, a forced-air assembly 44, and a thermal element 48. The plurality of walls 28 are positioned within the housing 24. The plurality of walls 28 include a first side wall 52, a second side wall 56, a top wall 60, a bottom wall 64, and a rear wall 68. At least one of the plurality of walls 28 defines a series of apertures 72 therein. The cavity 32 is defined by the plurality of walls 28. The access aperture 36 is positioned opposite the rear wall 68. The closure panel 40 is coupled to a front 76 of the housing 24. The closure panel 40 is movable between an open position (FIG. 1) and a closed position (FIG. 2). The closure panel 40 is configured to cover the access aperture 36 when the closure panel 40 is in the closed position. The forced-air assembly 44 is configured to induce airflow within the cavity 32. The thermal element 48 may be positioned upon the at least one of the plurality of walls 28 that defines the series of apertures 72. In such an example, the thermal element 48 may define a series of holes 80. The series of holes 80 are configured to align with the series of apertures 72. For example, individual holes of the series of holes 80 and individual apertures of the series of apertures 72 may coaxially overlap such that air passes through a given pairing of one of the individual holes and one of the individual apertures. The air is heated by the thermal element 48 as the air passes through the series of holes 80. Alternatively, the thermal element 48 may be positioned proximate to the at least one of the plurality of walls 28 that defines the series of apertures 72.

Referring again to FIGS. 1 and 2, the closure panel 40 can be coupled to the housing 24 by one or more hinges 84. The hinges 84 are positioned proximate to a first end of the appliance 20. The first end can be proximate to the first side wall 52. A user interface 88 can be provided at a second end of the appliance 20. The second end of the appliance 20 may correspond with, or be proximate to, the second side wall 56. The user interface 88 can include a display 92, an input keypad 96, and/or an opening button 100. Actuation of the opening button 100 by a user may disengage a latch 104 from a latch receptacle 108 to enable transitioning the closure panel 40 from the closed position to the open position. In various examples, the appliance 20 may be provided with a support surface 112 that is positioned within the cavity 32 and suspended above the bottom wall 64. In some examples, the support surface 112 may be suspended by a support structure 116. In the depicted example, the support structure 116 engages with the bottom wall 64 and an underside of the support surface 112 in a manner that permits rotation of the support surface 112 relative to the appliance 20.

Referring further to FIGS. 1 and 2, in various examples, the series of apertures 72 can include a first region 120 and a second region 124. In the depicted example, the first region 120 is positioned radially inward of the second region 124. Accordingly, the first region 120 may represent a surface area defined by a first radius, or a first range of radii, from a center of the rear wall 68. Similarly, the second region 124 may represent a surface area defined by a second radius, or a second range of radii, from the center of the rear wall 68. In the depicted example, the second region 124 is discontinuously positioned about the rear wall 68. As shown in FIG. 2, the forced-air assembly 44 in the depicted example includes a first forced-air assembly 44A and a second forced-air assembly 44B. In the depicted example, the first forced-air assembly 44A may be positioned behind the rear wall 68 and proximate to the second sidewall 56 and the top wall 60 (e.g., proximate to the series of apertures 72 depicted near the upper right corner of the cavity 32 in FIG. 1). Similarly, the second forced-air assembly 48 may be positioned proximate to the first side wall 52 and the bottom wall 64, with the second forced-air assembly 44B being positioned behind the rear wall 68 (e.g., proximate to the series of apertures 72 that are positioned near the lower left corner of the cavity 32 in FIG. 1).

Referring still further to FIGS. 1 and 2, forced-air assembly(ies) 44 induces airflow within the cavity 32. For example, the forced-air assembly(ies) 44 can draw air from the cavity 32 at the first region 120 of the series of apertures 72, as indicated by arrows 128. The airflow induced by activation of the forced-air assembly(ies) 44 can drive air into the cavity 32 at the second region 124 of the series of apertures 72, as indicated by arrows 132. Due to the positioning of the forced-air assembly(ies) 44 and the series of apertures 72, a forced convection airflow is established within the cavity 32. For example, the air from the cavity 32 is drawn toward the rear wall 68 proximate to a center of the rear wall 68 and the air drawn by the forced-air assembly(ies) 44 is driven into the cavity 32 proximate to a periphery of the rear wall 68 (e.g., proximate to the first side wall 52, the second sidewall 56, the top wall 60, and/or the bottom wall 68.). In the depicted example, the forced-air assembly(ies) 44 may be a centrifugal fan. Use of one or more of the centrifugal fans may enable a decrease in a thickness 136 of a rearward panel 140 of the housing 24. The rearward panel 140 can define a space 144 between an interior of the rearward panel 140 and a rearward surface of the rear wall 68. The space 144 can be employed to house the forced-air assembly(ies) 44 and also provide a channel for establishing the airflow discussed above. By having the second region 124 discontinuously positioned about the rear wall 68, airflow induced by the forced-air assembly(ies) 44 may encourage the development of eddy currents, convection, and/or a pressure differential within the space 144. Encouragement of the development of eddy currents, convections, and/or a pressure differential within the space 144 can enhance distribution of the heat generated by the thermal element 48, which may enhance heat transfer to the cavity 32. Enhanced heat transfer to the cavity 32 may be beneficial for examples where the appliance 20 is employed as a cooking apparatus for foodstuffs. In such examples, the foodstuff(s) can be placed within the cavity 32 for heating and/or cooking operations to be performed thereupon.

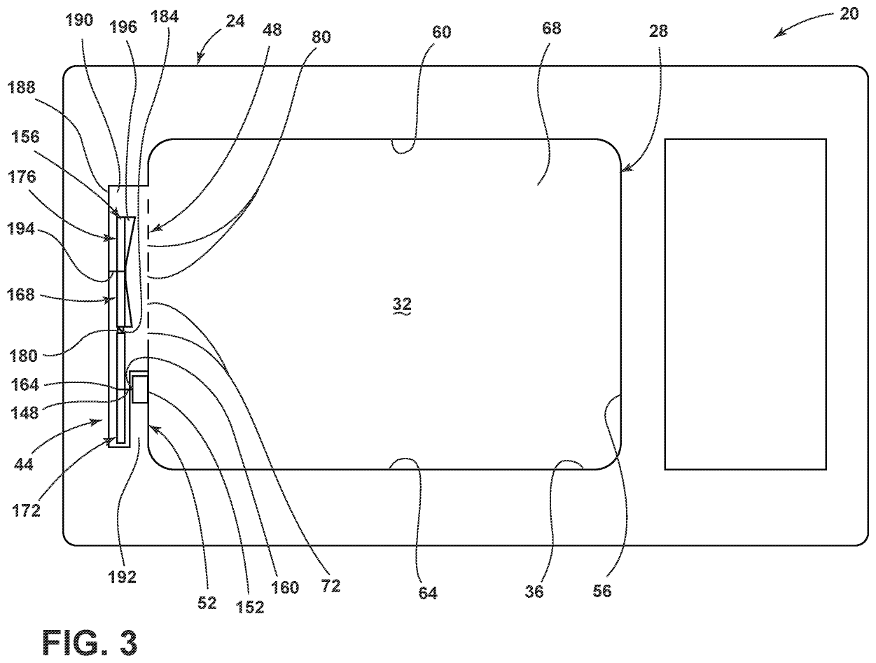

Referring now to FIG. 3, the forced-air assembly 44 is depicted according to one example. In the depicted example, the forced-air assembly 44 includes a driveshaft 148, a motor 152, and an air-moving member 156. The driveshaft 148 includes a first end 160 and a second end 164. The motor 152 is coupled to the first end 160 of the driveshaft 148. The air-moving member 156 is coupled to the second end 164 of the driveshaft 148. In the depicted example, the air-moving member 156 is coupled to the second end 164 of the driveshaft 148 by a gear assembly 168. The gear assembly 168 can include a plurality of gears. For example, the gear assembly 168 can include a first gear 172 and a second gear 176. However, the present disclosure is not so limited. It is contemplated that additional gears may be utilized beyond the first and second gears 172, 176. In the depicted example, the first gear 172 is directly coupled to the second end 164 of the driveshaft 148. Accordingly, as the motor 152 induces rotational motion of the driveshaft 148, the rotational motion of the driveshaft 148 causes the first gear 172 to rotate. A meshing engagement between teeth 180 of the first gear 172 and teeth 184 of the second gear 176 results in the transmission of rotational motion from the first gear 172 to the second gear 176. A space 190 is provided between the interior panel 188 and the first side wall 52. The space 190 houses the air-moving member 156, the first gear 172, the second gear 176, and at least a portion of the driveshaft 148. The motor 152 is positioned exterior to the space 190. More specifically, the interior panel 188 is contoured such that an alcove 192 is defined between the first side wall 52 and the interior panel 188. The alcove 192 receives the motor 152. In some examples, the motor 152 can be mounted to the first side wall 52.

Referring again to FIG. 3, in the depicted example, the second gear 176 is mounted to an interior panel 188 in a manner that permits rotational motion of the second gear 176. For example, the second gear 176 may be mounted to the interior panel 188 by an axle 194. The second gear 176 can include protrusions 196 extending therefrom such that rotation of the second gear 176 induces an airflow within the cavity 32. Accordingly, the second gear 176 may operate as a fan. Therefore, in the depicted example, the air-moving member 156 may be referred to as a fan. It is contemplated that the protrusions 196 may be unitarily or integrally formed with the second gear 176. For example, a cavity-facing surface of the second gear 176 can include the protrusions 196 extending therefrom while a circumferential surface of the second gear 176 is provided with the teeth 184 such that the air-moving member 156 includes the second gear 176, the teeth 184, and the protrusions 196 as a unitary body. The depicted arrangement of the forced-air assembly 44 can decrease an overall thickness of the appliance 20 in at least one dimension.

Referring further to FIG. 3, the decreased thickness in the at least one dimension may be attributed, at least in part, to the offset arrangement between the motor 152 and the air-moving member 156. For example, by having a rotational axis of the motor 152 offset from a rotational axis of the air-moving member 156, a footprint of the forced-air assembly 44 along a horizontal dimension may be decreased. While the footprint of the forced-air assembly 44 may be decreased along the horizontal dimension, the footprint of the forced-air assembly 44 may increase along a vertical dimension in the depicted example. However, the dimension along which the footprint is increased for the forced-air assembly 44 may be chosen such that the additional footprint extends into space that would otherwise be a void or otherwise available in the appliance 20 such that the thickness of the appliance 20 in at least one dimension may be decreased while minimizing or avoiding a negative impact on additional components of the appliance 20.

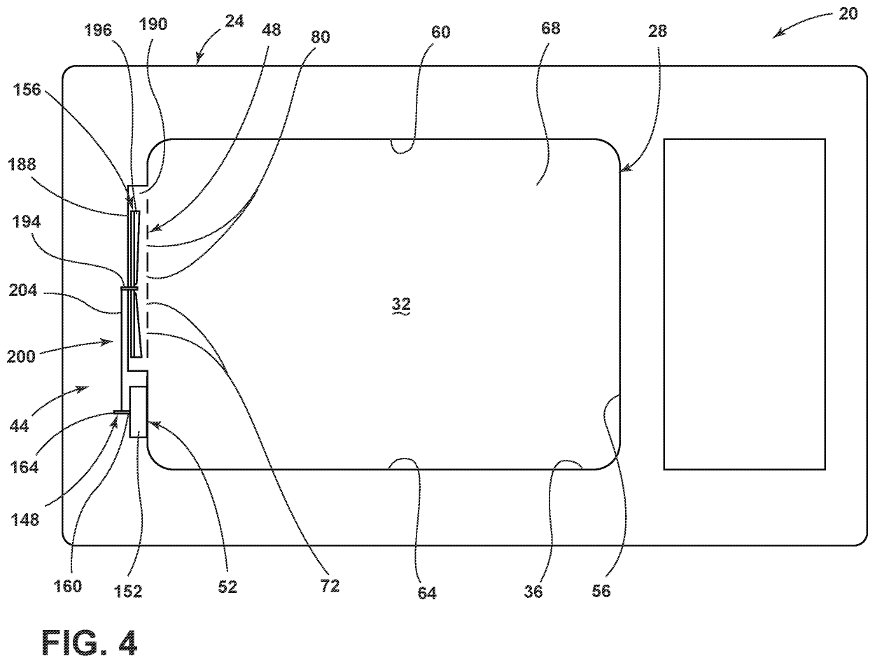

Referring to FIG. 4, the forced-air assembly 44 is depicted according to one example. In the depicted example, the forced-air assembly 44 includes the driveshaft 148, the motor 152, and the air-moving member 156. The driveshaft 148 includes the first end 160 and the second end 164. The motor 152 is coupled to the first end 160 of the driveshaft 148. The air-moving member 156 is coupled to the second end 164 of the driveshaft 148. In the depicted example, the air-moving member 156 is coupled to the second end 164 of the driveshaft 148 by a pulley assembly 200. The pulley assembly 200 can include a belt 204 that extends between the driveshaft 148 and the axle 194 of the air-moving member 156. In the depicted example, the air-moving member 156 is mounted to the interior panel 188 by way of the axle 194. The interior panel 188 of the depicted example is contoured such that the space 190 between the interior panel 188 and the first side wall 52 houses the air-moving member 156 but not the motor 152, the driveshaft 148, or the belt 204. As with the example depicted in FIG. 3, the air-moving member 156 is provided with the protrusions 196 that extend therefrom such that rotation of the air-moving member 156 induces airflow within the cavity 32.

Referring again to FIG. 4, rotational motion of the motor 152 is imparted to the driveshaft 148. The rotational motion of the driveshaft 148 is transmitted to the air-moving member 156 by way of the belt 204. The belt 204 extends between the driveshaft 148 and the axle 194. As with the example depicted in FIG. 3, by having the rotational axis of the motor 152 offset from the rotational axis of the air-moving member 156, the footprint of the forced-air assembly 44 along the horizontal dimension may be decreased. While the footprint of the forced-air assembly 44 may be decreased along the horizontal dimension, the footprint of the forced-air assembly 44 may increase along the vertical dimension in the depicted example. However, the dimension along which the footprint is increased for the forced-air assembly 44 may be chosen such that the additional footprint extends into space that would be void or otherwise available in the appliance 20 such that the thickness of the appliance 20 in at least one dimension may be decreased while minimizing or avoiding a negative impact on additional components of the appliance 20.

Referring again to FIGS. 2-4, the thermal element 48 can be a film that is applied to at least one of the plurality of walls 28 (e.g., the first side wall 52, the second side wall 56, the top wall 60, the bottom wall 64, and/or the rear wall 68). In various examples, the film may be a thermoresistive film. The thermoresistive film can transform electrical energy into thermal energy when electricity is applied to the thermoresistive film. In some examples, the thermal element 48 can include at least one metallic component chosen from tin oxide, graphite, silver, and silver palladium (i.e., tin oxide, graphite, silver, and/or silver palladium). The thermal element 48 can be applied to an inner surface or an outer surface of the at least one of the plurality of walls 28. The inner surface of the plurality of walls 28 is intended to refer to the surface of the plurality of walls 28 that faces the cavity 32. The exterior surface of the plurality of walls 28 is intended to refer to the surface of the plurality of walls 28 that does not face the cavity 32. Said another way, the exterior surface of the plurality of walls 28 is intended to refer to the surface of the plurality of walls that is facing an interior of the housing 24.

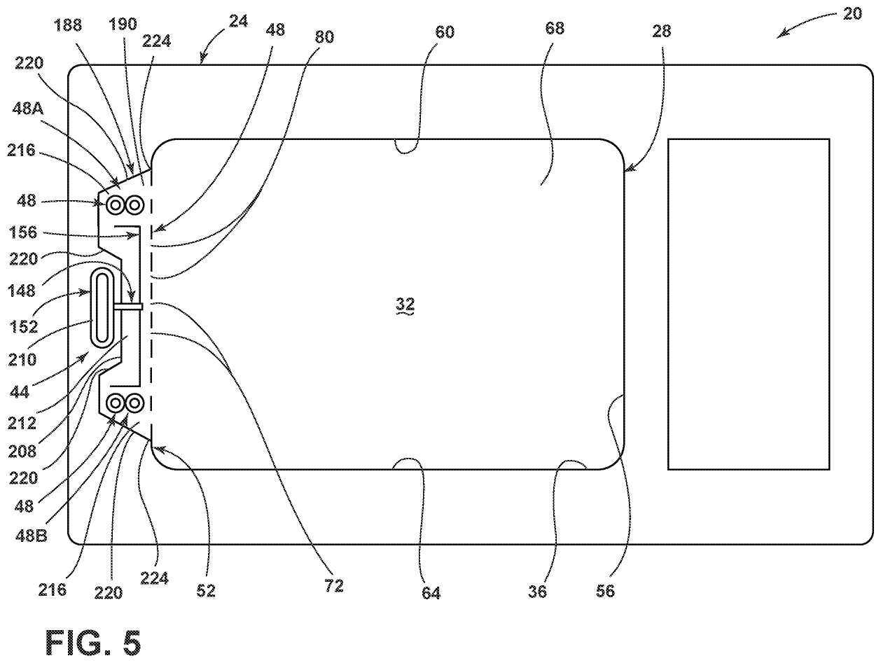

Referring to FIGS. 5-7, the interior panel 188 is positioned between the housing 24 and at least one of the plurality of walls 28. The interior panel 188 can support the motor 152 of the forced-air assembly 44. In various examples, the driveshaft 148 of the forced-air assembly 44 can extend through the interior panel 188. The interior panel 188 is contoured such that a recessed area 208 is defined by the interior panel 188. At least a portion of the motor 152 can be positioned within the recessed area 208. In some examples, an entirety of the motor 152 can be positioned within the recessed area 208. For example, an entirety of the motor 152 can be positioned within the recessed area 208 such that a rearward surface 210 of the motor 152 is substantially coplanar with the interior panel 188 in a region of the interior panel 188 that is external to the recessed area 208. In the depicted examples, the thermal element 48 is positioned proximate to at least one of the plurality of walls 28. In various examples, the thermal element 48 can be positioned within the space 190 defined by the at least one of the plurality of walls 28 and the interior panel 188. Alternatively, the thermal element 48 can be positioned within the cavity 32. It may be beneficial to position the thermal element 48 immediately adjacent to at least a portion of the series of apertures 72.

With specific reference to FIG. 5, the thermal element 48 is positioned within the space 190 defined by the at least one of the plurality of walls 28 and the interior panel 188. The air-moving member 156 is also positioned within the space 190 defined by the at least one of the plurality of walls 28 and the interior panel 188. More specifically, the air-moving member 156 and the thermal element 48 are positioned between the first side wall 52 and the interior panel 188. The thermal element 48 is immediately adjacent to the air-moving member 156. For example, the appliance 20 may be provided with a first thermal element 48A and a second thermal element 48B. In such an example, the first thermal element 48A may be positioned vertically above the air-moving member 156 and within the space 190 while the second thermal element 48B may be positioned vertically below the air-moving member 156 and within the space 190.

Referring again to FIG. 5, in some examples, the thermal element 48 may be circumferentially, and substantially continuously, positioned about the air-moving member 156. Said another way, the air-moving member 156 may define a first circumference and the thermal element 48 may define a second circumference, where the first circumference is less than the second circumference. Accordingly, the thermal element 48 and the air-moving member 156 may be concentrically arranged relative to one another. Regardless of the particular arrangement of the thermal element 48 and the air-moving member 156, the thermal element 48 heats air within the space 190 and the air-moving member 156 induces an airflow to provide heated air that is circulated throughout the cavity 32. The heated air is directed from the space 190 to the cavity 32 by way of the series of apertures 72. As a result of the contouring of the interior panel 188 that provides the recessed area 208, the space 190 includes a first depth in a central region 212 thereof and a second depth in peripheral regions 216 thereof. The second depth may be greater than the first depth. While the central region 212 and the peripheral regions 216 are discussed as having first and second depths, respectively, it is contemplated that the first and second depths need not be uniform. For example, the interior panel 188 may be provided with sloped regions 220 that transition between the central region 212 and the peripheral regions 216. Additionally, or alternatively, the interior panel 188 may be provided with the sloped regions 220 as transitions between the peripheral regions 216 and outward extremes 224 of the interior panel 188.

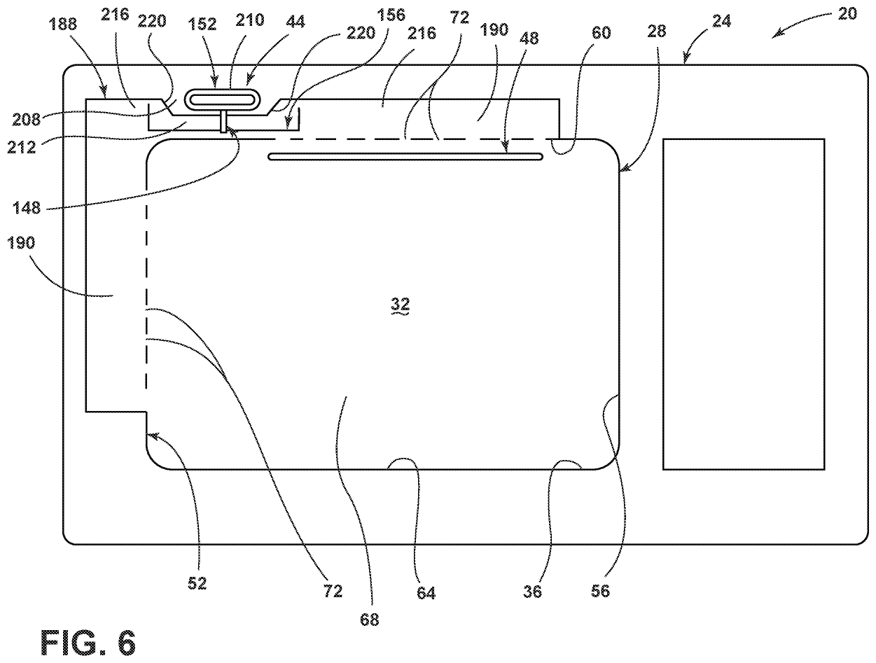

Referring now to FIG. 6, the thermal element 48 is positioned within the cavity 32. In the depicted example, the thermal element 48 is positioned immediately adjacent to the top wall 60 of the plurality of walls 28. The thermal element 48 is immediately adjacent to at least a portion of the series of apertures 72. The air-moving member 156 is positioned within the space 190 defined by the top wall 60 and the interior panel 188. In the depicted example, the space 190 is generally L-shaped. Accordingly, the space 190 defined by the at least one of the plurality of walls 28 and the interior panel 188 extends along a first wall (e.g., the top wall 60) of the plurality of walls 28 and a second wall (e.g., the first side wall 52) of the plurality of walls 28. In various examples, the space 190 that is defined between the first wall, the second wall, and the interior panel 188 may include two legs, or sections, that are non-parallel with one another. For example, the first wall and the second wall may be perpendicular to one another. Accordingly, a first section of the space 190 may be perpendicular with a second section of the space 190, with the first section corresponding with the first wall and the second section corresponding with the second wall.

Referring again to FIG. 6, in the depicted example, the first and second walls each define a portion of the series of apertures 72. In one example, airflow induced by activation of the forced-air assembly 44 may include heated air that is proximate to the thermal element 48 rising into the space 190 proximate to the top wall 60 as a result of the series of apertures 72 defined by the top wall 60. As the air-moving member 156 of the forced-air assembly 44 rotates about the driveshaft 148, the heated air rising through the series of apertures 72 defined by the top wall 60 can be driven into the cavity 32 by way of the series of apertures 72 defined by the top wall 60 and/or the series of apertures 72 defined by the first side wall 52. The air-moving member 156 may be at least partially positioned behind a section of the top wall 60 that does not define the series of apertures 72. Accordingly, airflow induced by the rotation of the air-moving member 156 may contact an interior surface of an intact portion of the top wall 60 such that eddy currents, convection, and/or a pressure differential is developed within the space 190. The positioning of the air-moving member 156 at least partially behind the intact portion of the top wall 60 can aid in driving the air within the space 190 toward the series of apertures 72 defined by the first side wall 52. Therefore, at least a portion of the airflow induced by the rotation of the air-moving member 156 may be driven to exit the space 190 by way of the series of apertures 72 defined by the first side wall 52 and the top wall 60. In so doing, a thermal gradient within the cavity 32 may be decreased.

Referring further to FIG. 6, in some examples, the top wall 60 may be defined as an air inlet. In such examples, the first side wall 52 and/or at least a portion of the top wall 60 may be referred to as first and second air outlets, respectively. As with the example depicted in FIG. 5, as a result of the contouring of the interior panel 188 that provides the recessed area 208, the space 190 includes a first depth in the central region 212 thereof and a second depth in the peripheral regions 216 thereof. While the central region 212 and the peripheral regions 216 are discussed as having first and second depths, respectively, it is contemplated that the first and second depths need not be uniform. For example, the interior panel 188 may be provided with the sloped regions 220 that transition between the central region 212 and the peripheral regions 216.

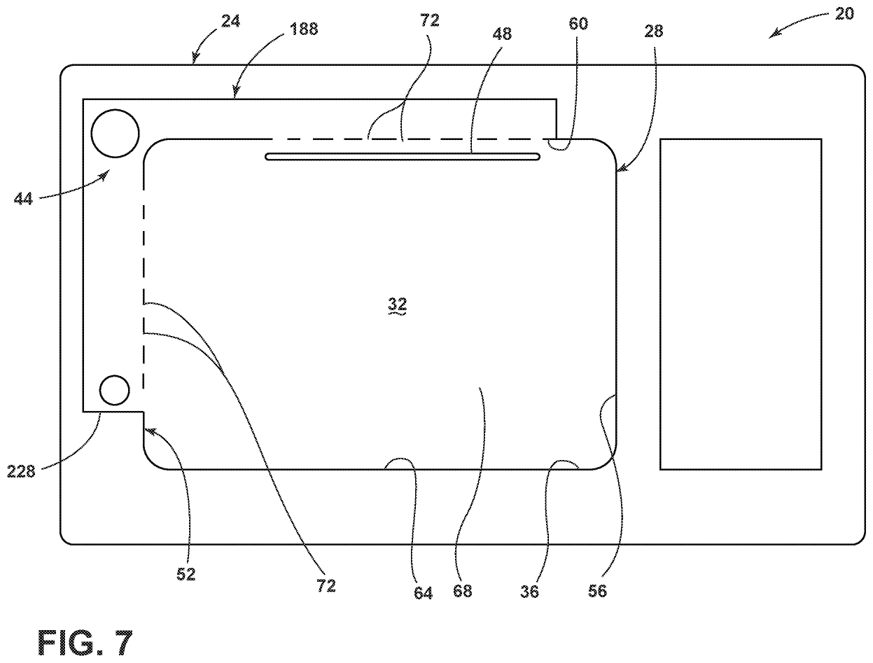

Referring to FIG. 7, the thermal element 48 is positioned within the cavity 32. In the depicted example, the thermal element 48 is positioned immediately adjacent to the top wall 60 of the plurality of walls 28. The thermal element 48 is immediately adjacent to at least a portion of the series of apertures 72. The forced-air assembly 44 is positioned within the space 190 defined by the top wall 60 and the interior panel 188. In the depicted example, the forced-air assembly 44 may be a centrifugal fan. The centrifugal fan may place the motor 152, the driveshaft 148, and the air-moving member 156 within a housing of the forced-air assembly 44. In the depicted example, the space 190 is generally L-shaped. Accordingly, the space 190 defined by the at least one of the plurality of walls 28 and the interior panel 188 extends along a first wall (e.g., the top wall 60) of the plurality of walls 28 and a second wall (e.g., the first side wall 52) of the plurality of walls 28. In various examples, the space 190 that is defined between the first wall, the second wall, and the interior panel 188 may include two legs, or sections, that are non-parallel with one another. For example, the first wall and the second wall may be perpendicular to one another. Accordingly, a first section of the space 190 may be perpendicular with a second section of the space 190, with the first section corresponding with the first wall and the second section corresponding with the second wall.

Referring again to FIG. 7, in the depicted example, the first and second walls each define a portion of the series of apertures 72. In one example, airflow induced by activation of the forced-air assembly 44 may include heated air that is proximate to the thermal element 48 rising into the space 190 proximate to the top wall 60 as a result of the series of apertures 72 defined by the top wall 60. As the force-air assembly 44 operates, the heated air rising through the series of apertures 72 defined by the top wall 60 can be driven into the cavity 32 by way of the series of apertures 72 defined by the top wall 60 and/or the series of apertures 72 defined by the first side wall 52. The forced-air assembly 44 may be at least partially positioned behind a section of the first side wall 52 and/or a section of the top wall 60 that does not define the series of apertures 72. Accordingly, airflow induced by the operation of the force-air assembly 44 may contact an interior surface of an intact portion of the first side wall 52 and/or the top wall 60 such that eddy currents, convection, and/or a pressure differential is developed within the space 190. The positioning of the forced-air assembly 44 at least partially behind the intact portion of the top wall 60 can aid in driving the air within the space 190 toward the series of apertures 72 defined by the first side wall 52. Therefore, at least a portion of the airflow induced by the operation of the forced-air assembly 44 may be driven to exit the space 190 by way of the series of apertures 72 defined by the first side wall 52 and/or the top wall 60. In so doing, a thermal gradient within the cavity 32 may be decreased.

Referring further to FIG. 7, in some examples, the top wall 60 may be defined as an air inlet. In such examples, the first side wall 52 and/or at least a portion of the top wall 60 may be referred to as first and second air outlets, respectively. In various examples, a second centrifugal fan may be provided in the appliance 20. In such examples, the second centrifugal fan may be positioned proximate to a lower wall 228 of the interior panel 188, where the lower wall 228 is positioned behind the first side wall 52 and proximate to the bottom wall 64. Accordingly, in such an example, the appliance 20 can include the first forced-air assembly 44A and the second forced-air assembly 44B, where the second forced-air assembly 44B is the second centrifugal fan. Such an arrangement of the appliance 20 may encourage heated air within the space 190 to enter the cavity 32 while also further decreasing a thermal gradient within the cavity 32. In some examples, the first forced-air assembly 44A can “pull” air from a region of the space 190 that is proximate to the top wall 68 and drive the heated air toward the second forced-air assembly 44B. Similarly, the second forced-air assembly 44B can “pull” heated air from a region of the space 190 that is proximate to the first forced-air assembly 44A and drive the heated air into the cavity 32. It is contemplated that the second forced-air assembly 44A may “pull” at least a portion of the air located within the cavity 32 as a result of the second forced-air assembly 44 being positioned proximate to at least a portion of the series of apertures 72 defined by the first side wall 52.

The appliance 20 discussed in the present disclosure can provide heated air flow to the cavity 32 for a variety of purposes. A benefit of the examples discussed in the present disclosure is that a footprint of the appliance 20, or surface area that the appliance 20 occupies, can be decreased while maintaining functionality of the appliance 20. By decreasing the footprint of the appliance 20, a volume of the cavity 32 may be increased and/or an overall size (e.g., volume) of the appliance 20 may be decreased while maintaining the cavity 32 at a given volume. Accordingly, a consumer can be provided with a more compact execution of the appliance 20 while maintaining a capacity of the cavity 32 of the appliance 20. Alternatively, the consumer can be provided with an increased capacity of the cavity 32 without increasing the footprint of the appliance 20. For example, the thickness 136 discussed with regard to FIG. 2 may be greater than 100 mm in appliances that do not employ the teachings of the present disclosure. However, the examples of the appliance 20 discussed herein are capable of achieving the thickness 136 as less than or equal to about 75 mm, less than or equal to about 70 mm, less than or equal to about 65 mm, less than or equal to about 60 mm, less than or equal to about 55 mm, less than or equal to about 50 mm, less than or equal to about 45 mm, less than or equal to about 40 mm, less than or equal to about 35 mm, less than or equal to about 30 mm, and/or combinations or ranges thereof.

The appliance disclosed herein is further summarized in the following paragraphs and further characterized by combinations of any and all the various aspects described therein.

According to another aspect of the present disclosure, an appliance includes a housing, a plurality of walls, a cavity, an access aperture, a closure panel, a forced-air assembly, and a thermal element. The plurality of walls are positioned within the housing. The plurality of walls include a first side wall, a second side wall, a top wall, a bottom wall, and a rear wall. At least one of the plurality of walls defines a series of apertures therein. The cavity is defined by the plurality of walls. The access aperture is positioned opposite the rear wall. The closure panel is coupled to a front of the housing. The closure panel is movable between an open position and a closed position. The closure panel is configured to cover the access aperture when the closure panel is in the closed position. The forced-air assembly is configured to induce airflow within the cavity. The thermal element is positioned upon the at least one of the plurality of walls that defines the series of apertures. The thermal element defines a series of holes. The series of holes are configured to align with the series of apertures. Air is heated by the thermal element as the air passes through the series of holes.

According to another aspect of the present disclosure, a thermal element is a film applied to a rear wall.

According to another aspect of the present disclosure, a film is a thermoresistive film.

According to another aspect of the present disclosure, a thermal element includes at least one metallic component chosen from tin oxide, graphite, silver, and silver palladium.

According to another aspect of the present disclosure, a forced-air assembly includes a driveshaft with a first end and a second end, a motor coupled to the first end of the driveshaft, and an air-moving member coupled to the second end of the driveshaft.

According to another aspect of the present disclosure, an air-moving member is coupled to a second end of a driveshaft by a pulley assembly.

According to another aspect of the present disclosure, an air-moving member is coupled to a second end of a driveshaft by a gear assembly.

According to another aspect of the present disclosure, an air-moving member is a fan.

According to another aspect of the present disclosure, a fan is a centrifugal fan.

According to another aspect of the present disclosure, a forced-air assembly draws air from a cavity at a first region of a series of apertures, wherein the forced-air assembly drives air into the cavity at a second region of the series of apertures.

According to another aspect of the present disclosure, an appliance includes a housing, a cavity, and access aperture, a plurality of walls, a closure panel, a forced-air assembly, and an interior panel. The cavity is defined by the plurality of walls. The access aperture is positioned opposite the rear wall. The plurality of walls are positioned within the housing. At least one of the plurality of walls defines a series of apertures therein. The closure panel is coupled to a front of the housing. The closure panel is movable between an open position and a closed position. The closure panel is configured to cover the access aperture when the closure panel is in the closed position. The forced-air assembly is configured to induce airflow within the cavity. The forced-air assembly includes a motor, a driveshaft, and an air-moving member. The interior panel is positioned between the housing and at least one of the plurality of walls. The interior panel supports the motor of the forced-air assembly. The driveshaft of the forced-air assembly extends through the interior panel. The interior panel is contoured such that a recessed area is defined by the interior panel. At least a portion of the motor is positioned within the recessed area.

According to another aspect of the present disclosure, a thermal element is positioned proximate to at least one of a plurality of walls.

According to another aspect of the present disclosure, a thermal element is positioned within a space defined by at least one of a plurality of walls and an interior panel.

According to another aspect of the present disclosure, a thermal element is adjacent to an air-moving member.

According to another aspect of the present disclosure, a thermal element is positioned within a cavity.

According to another aspect of the present disclosure, a thermal element is positioned immediately adjacent to a series of apertures.

According to another aspect of the present disclosure, a thermal element is positioned immediately adjacent to a top wall of a plurality of walls.

According to another aspect of the present disclosure, an air-moving member is positioned within a space defined by at least one of a plurality of walls and an interior panel.

According to another aspect of the present disclosure, a space is defined by at least one of a plurality of walls and an interior panel extends along a first wall of the plurality of walls and a second wall of the plurality of walls.

According to another aspect of the present disclosure, a first wall and a second wall are non-parallel with one another.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, layouts, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1. An appliance, comprising:
a housing;
a plurality of walls positioned within the housing, wherein the plurality of walls comprises a first side wall, a second side wall, a top wall, a bottom wall, and a rear wall, and wherein at least one of the plurality of walls defines a series of apertures therein;
a cavity defined by the plurality of walls;
an access aperture positioned opposite the rear wall;
a closure panel coupled to a front of the housing, wherein the closure panel is movable between an open position and a closed position, and wherein the closure panel is configured to cover the access aperture when the closure panel is in the closed position;
a forced-air assembly that is configured to induce airflow within the cavity; and
a thermal element positioned upon the at least one of the plurality of walls that defines the series of apertures, wherein the thermal element defines a series of holes, wherein the series of holes are configured to align with the series of apertures, and wherein air is heated by the thermal element as the air passes through the series of holes.

2. The appliance of claim 1, wherein the thermal element is a film applied to the rear wall.

3. The appliance of claim 2, wherein the film is a thermoresistive film.

4. The appliance of claim 1, wherein the thermal element comprises at least one metallic component chosen from tin oxide, graphite, silver, and silver palladium.

5. The appliance of claim 1, wherein the forced-air assembly comprises:
a driveshaft having a first end and a second end;
a motor coupled to the first end of the driveshaft; and
an air-moving member coupled to the second end of the driveshaft.

6. The appliance of claim 5, wherein the air-moving member is coupled to the second end of the driveshaft by a pulley assembly.

7. The appliance of claim 5, wherein the air-moving member is coupled to the second end of the driveshaft by a gear assembly.

8. The appliance of claim 5, wherein the air-moving member is a fan.

9. The appliance of claim 8, wherein the fan is a centrifugal fan.

10. The appliance of claim 1, wherein the forced-air assembly draws air from the cavity at a first region of the series of apertures, and wherein the forced-air assembly drives air into the cavity at a second region of the series of apertures.

11. An appliance, comprising:
a housing;
a cavity defined by the plurality of walls;
an access aperture positioned opposite the rear wall;
a plurality of walls positioned within the housing, wherein at least one of the plurality of walls defines a series of apertures therein;
a closure panel coupled to a front of the housing, wherein the closure panel is movable between an open position and a closed position, and wherein the closure panel is configured to cover the access aperture when the closure panel is in the closed position;
a forced-air assembly that is configured to induce airflow within the cavity, wherein the forced-air assembly comprises a motor, a driveshaft, and an air-moving member; and
an interior panel positioned between the housing and at least one of the plurality of walls, wherein the interior panel supports the motor of the forced-air assembly, wherein the driveshaft of the forced-air assembly extends through the interior panel, wherein the interior panel is contoured such that a recessed area is defined by the interior panel, and wherein at least a portion of the motor is positioned within the recessed area.

12. The appliance of claim 11, further comprising:
a thermal element positioned proximate to the least one of the plurality of walls.

13. The appliance of claim 12, wherein the thermal element is positioned within a space defined by the at least one of the plurality of walls and the interior panel.

14. The appliance of claim 12, wherein the thermal element is adjacent to the air-moving member.

15. The appliance of claim 12, wherein the thermal element is positioned within the cavity.

16. The appliance of claim 15, wherein the thermal element is positioned immediately adjacent to the series of apertures.

17. The appliance of claim 16, wherein the thermal element is positioned immediately adjacent to a top wall of the plurality of walls.

18. The appliance of claim 16, wherein the air-moving member is positioned within a space defined by the at least one of the plurality of walls and the interior panel.

19. The appliance of claim 18, wherein the space defined by the at least one of the plurality of walls and the interior panel extends along a first wall of the plurality of walls and a second wall of the plurality of walls.

20. The appliance of claim 19, wherein the first wall and the second wall are non-parallel with one another.
